(19) United States
(12) Patent Application Publication
(10) Pub. No.: US 2015/0109666 A1
(43) Pub. Date: Apr. 23, 2015

(54) ARRAY SUBSTRATE AND MANUFACTURING METHOD THEREOF, 3D DISPLAY DEVICE

(71) Applicant: BOE TECHNOLOGY GROUP CO., LTD., Beijing (CN)

(72) Inventors: Wei Wei, Beijing (CN); Yanbing Wu, Beijing (CN)

(73) Assignee: BOE TECHNOLOGY GROUP CO., LTD., Beijing (CN)

(21) Appl. No.: 14/403,345

(22) PCT Filed: Dec. 5, 2013
(86) PCT No.: PCT/CN2013/088626

§ 371 Date: Nov. 24, 2014

(30) Foreign Application Priority Data
Sep. 2, 2013 (CN) 201310392404.5

(51) Int. Cl. G02B 27/26

(52) U.S. Cl. CPC G02B 27/26
USPC 359/462; 427/97.3

(57) ABSTRACT

An array substrate, comprising: a base substrate (100), a pixel array layer (200) located on the base substrate (100) and a grating layer for 3D display that is formed by a plurality of light blocking strips (400) separated at a preset interval. The grating layer is located at a side of the base substrate (100) facing the pixel array layer (200), or is located at a side of the base substrate (100) away from the pixel array layer (200), and the light blocking strips (400) have a property of reflecting light, and is configured to reflect light that is to be emitted through the base substrate (100) to the pixel array layer (200). With the array substrate, the display brightness of the display device can be enhanced.

### TECHNICAL FIELD

Embodiments of the present invention relate to an array substrate and a manufacturing method thereof, a three-dimensional (3D) display device.

### BACKGROUND

The basic structure of a grating, naked-eye 3D display device that is at present relatively mature includes a layer of grating attached to an outer side of an upper polarizing sheet of a display screen. The layer of grating acts to output light that is emitted by pixels of the display screen to the left and right eyes of a viewer, respectively, so as to generate a stereovision effect.

The structures of existing naked-eye 3D display devices are shown in FIG. 1 and FIG. 2 respectively. The display device as shown in FIG. 1 includes a display screen formed with a color filter substrate 2, an array substrate 3, an upper polarizing sheet 1 on the color filter substrate 2, and a lower polarizing sheet 4 beneath the array substrate, and a liquid crystal layer 7 is located between the color filter substrate 2 and the array substrate 3. A grating substrate 5 is provided on the upper polarizing sheet 1, and a grating layer 6 is formed on the grating substrate 5. The grating layer 6 functions as a parallax barrier, so as to produce left-eye and right-eye visual zones within the visual zone of the display device.

The display device as shown in FIG. 2 has a structure similar to that of the display device in FIG. 1, and the only difference lies in that a grating layer 6 is provided between an upper polarizing sheet 1 and a grating substrate 5. A naked-eye 3D display can also be realized by this structure. The grating substrate 5 may be a glass or plastic substrate.

In the practical application process, the above-mentioned naked-eye 3D display technologies have the following problems:

(1) Due to addition of a grating substrate, the light transmittance of the display device is relatively low, and part of light may be blocked by the grating itself so the light cannot be transmitted out by the display device, so that the brightness of the display device is relatively low. Furthermore, due to presence of the grating substrate, the overall thickness of the display device is increased.

(2) A grating region needs to be aligned with a pixel region, but in a manufacturing process, it is difficult for a grating substrate formed with a grating layer to be aligned with and attached to a display screen, so that the yield is lower; and moreover, the low accuracy of alignment of the grating and pixels on an array substrate also affects the display effect of the display device greatly. In addition, a special producing process for alignment and attachment is necessary, which makes the display device suffer from a higher cost.

In order to solve the above issues, it is possible that a grating layer 6 is directly produced on a color filter substrate 2, namely, the grating layer 6 lies between the color filter substrate 2 and an upper polarizing sheet 1, as shown in FIG. 3. The layered structure of the display device underneath the color filter substrate 2 is the same as the layered structure of the display screen underneath the color filter substrate 2 shown in FIG. 1 or FIG. 2. In this configuration, only the grating substrate is omitted, and the grating layer 6 is provided between the color filter substrate 2 and the upper polarizing sheet 1. In this way, the above (1) and (2) problems can be solved partly, but the brightness of the whole display device still cannot be improved.

### SUMMARY

In an aspect of the invention, there is provided an array substrate, comprising: a base substrate, a pixel array layer located on the base substrate and a grating layer for three-dimensional (3D) display that is formed by a plurality of light blocking strips separated at a preset interval; the grating layer is located at a side of the base substrate facing the pixel array layer, or the grating layer is located at a side of the base substrate away from the pixel array layer, and the light blocking strips have a property of reflecting light, and is configured to reflect light that is to be emitted through the base substrate to the pixel array layer.

In another aspect of the invention, there is further provided a 3D display device, comprising the array substrate stated as any item above.

In still another aspect of the invention, there is further provided a manufacturing method of an array substrate, comprising: forming a pixel array layer on a surface of a base substrate at one side; forming a pattern of a grating layer for 3D display, that is formed by arranging a plurality of light blocking strips separated at a preset interval, at the other side of the base substrate, and the light blocking strips have a property of reflecting light.

In still another aspect of the invention, there is further provided a manufacturing method of an array substrate, comprising: forming a pattern of a pixel electrode layer in the pixel array layer at a side of the base substrate; forming pattern of a grating layer for 3D display, that is formed by arranging a plurality of light blocking strips separated at a preset interval, at a side of the pixel electrode layer away from the base substrate; forming an aligning layer at a side of the grating layer away from the base substrate, and the light blocking strips have a property of reflecting light.

In still another aspect of the invention, there is further provided a manufacturing method of an array substrate, comprising: forming a pattern of a grating layer for 3D display, that is formed by arranging a plurality of light blocking strips separated at a preset interval, at a side of the base substrate; forming a pixel array layer at a side of the grating layer away from the base substrate, and the light blocking strips have a property of reflecting light.

In embodiments of the invention, as light blocking strips of the grating layer have a property of reflecting light, light that is emitted from a backlight source and not transmitted through the grating layer are reflected back to the backlight source. The backlight source usually has a light guide plate for diffusing light, and light reflected back to the backlight source are reflected by the light guide plate again so that the light can pass through the grating layer. Thus, the display brightness of the display device can be increased.

### BRIEF DESCRIPTION OF THE DRAWINGS

In order to illustrate the technical solution of the embodiments of the invention more clearly, the drawings of the embodiments will be briefly described below; it is obvious that the drawings as described below are only related to some embodiments of the invention, but are not limitative of the invention.

FIG. 1 is a structurally schematic view illustrating a conventional naked-eye 3D display device;

FIG. 2 is a structurally schematic view illustrating another conventional naked-eye 3D display device;

FIG. 3 is a structurally schematic view illustrating still another conventional naked-eye 3D display device;

FIG. 4 is a structurally schematic view illustrating an array substrate according to an embodiment of the invention;

FIG. 5 is a structurally schematic view illustrating another array substrate according to an embodiment of the invention;

FIG. 6 is a structurally schematic view illustrating still another array substrate according to an embodiment of the invention;

FIG. 7 is a structurally schematic view illustrating still another array substrate according to an embodiment of the invention;

FIG. 8 is a structurally schematic view illustrating still another array substrate according to an embodiment of the invention;

FIG. 9 is a structurally schematic view illustrating still another array substrate according to an embodiment of the invention;

FIG. 10 is a structurally schematic view illustrating still another array substrate according to an embodiment of the invention;

FIG. 11 is a diagram illustrating the principle of 3D display after the array substrate in FIG. 10 is formed into a 3D display device;

FIG. 12 is a structurally schematic view illustrating still another array substrate according to an embodiment of the invention; and

FIG. 13 is a structurally schematic view illustrating a display device that includes the array substrate in FIG. 5.

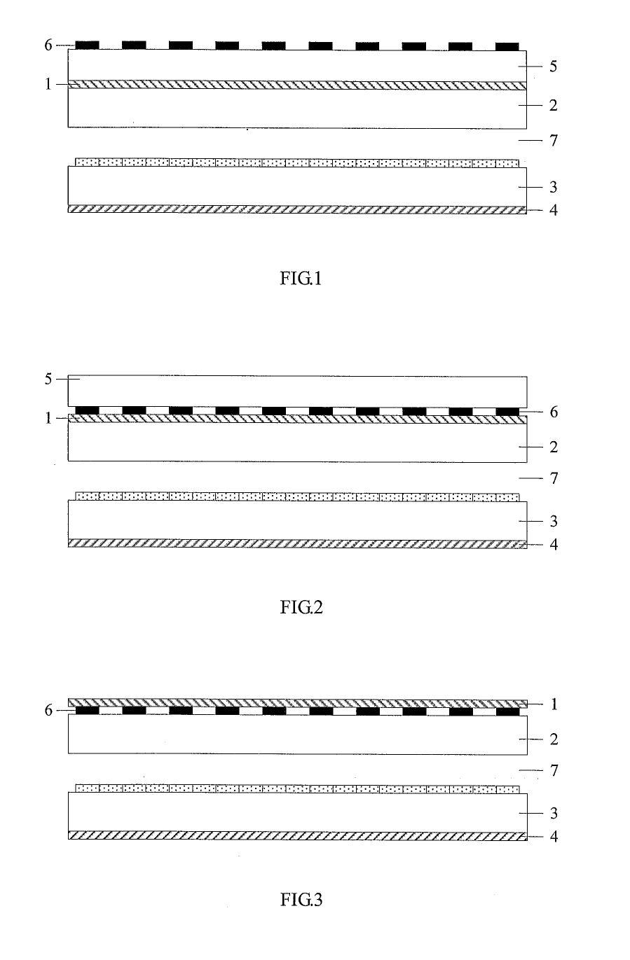

### DETAILED DESCRIPTION

In order to make objects, technical details and advantages of the embodiments of the invention apparent, hereinafter, the technical solutions of the embodiments of the invention will be described in a clearly and fully understandable way in connection with the drawings related to the embodiments of the invention. It is obvious that the described embodiments are just a part but not all of the embodiments of the invention. Based on the described embodiments of the invention, those ordinarily skilled in the art can obtain other embodiment(s), without any inventive work, which come(s) within the scope sought for protection by the invention.

Unless otherwise defined, the technical terminology or scientific terminology used here should have the same meaning as commonly understood by one of ordinary skill in the art to which this invention belongs. Likewise, a term “a,” “an,” “the” or the like does not indicate limitation in number, but specifies the presence of at least one. A term “comprises,” “comprising,” “includes,” “including” or the like means that an element or article ahead of this term encompasses element(s) or article(s) listed behind this term and the equivalents thereof, but does not preclude the presence of other elements or articles. “Upper,” “lower,” “left,” “right” or the like is only used to describe a relative position relationship, and when an absolute position of the described object is changed, the relative position relationship might also be changed accordingly.

An array substrate of an embodiment of the present invention includes: a base substrate and a pixel array layer located on the base substrate. In order that light that is not transmitted through a grating layer upon display can be reflected to a backlight source, and then is reflected by the backlight source again so as to allow the reflected light to be transmitted through the grating layer, and consequently the display brightness is enhanced, the array substrate further includes a grating layer for 3D display that is formed by a plurality of light-blocking strips separated at a preset interval, and the light-blocking strips of the grating layer have the property of reflecting light. The grating layer is located at the side of the pixel array layer away from the base substrate, or the grating layer is located at the side of the base substrate facing the pixel array layer, or the grating layer is located at a side of the base substrate opposed to the pixel array. The light-blocking strips are capable of reflecting the light that is to be emitted through the base substrate to the pixel array layer. The grating layer is configured for outputting light emitted by pixels in a display screen to the left and right eyes of a viewer, respectively, so as to produce a 3D visual effect, thereby achieving a naked-eye 3D display.

The pixel array layer may include individual layers of a thin film transistor (including a gate line layer, a gate insulating layer, an active layer, a source/drain layer), a pixel electrode layer, a passivation layer, an aligning layer, and other functional layers and structural layers, which are formed on the base substrate. The light-blocking strips extend in parallel to each other on a surface of the base substrate.

### Embodiment 1

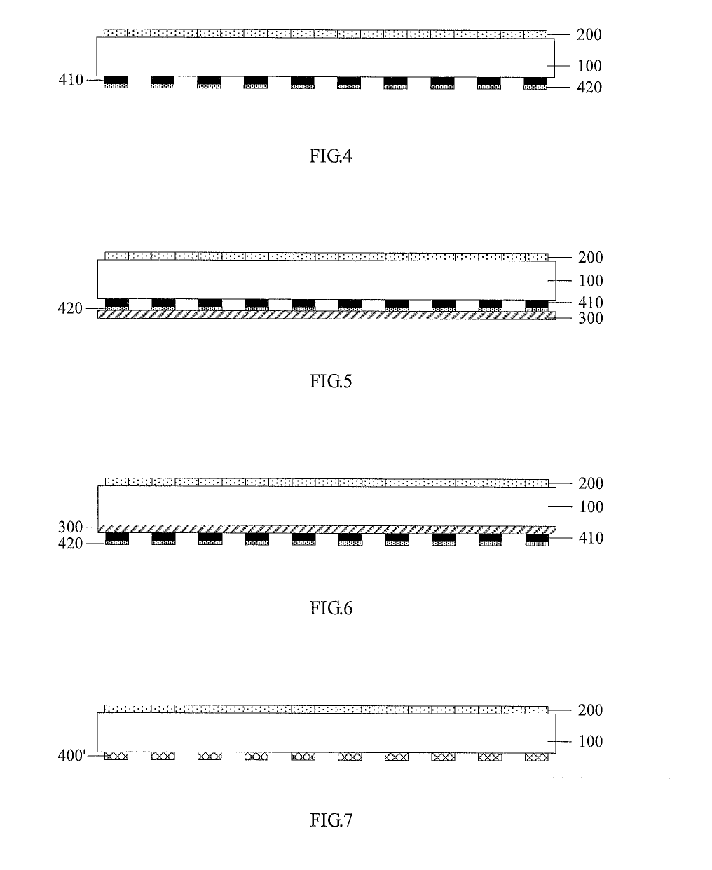

An array substrate provided by the embodiment, as shown in FIG. 4, includes: a base substrate 100 (such as a transparent substrate of glass or quartz) and a pixel array layer 200 located on the base substrate 100. The pixel array layer 200 in operation is adjacent to a liquid crystal layer. The array substrate further includes: a grating layer that is located under the base substrate 100 and is formed by a plurality of light-blocking strips 400 separated at a preset interval.

In the embodiment, each of the light-blocking strips 400 includes a light-shielding layer 410 and a light-reflecting layer 420, and the light-shielding layer 410 lies between the base substrate 100 and the light-reflecting layer 420. In order to realize better 3D display visual angle property, both the width and spacing of the light-blocking strips can be set in advance. In order not to affect the 3D display viewing angle property, the projection of the light-reflecting layer 420 on the base substrate 100 is covered by the projection of the light-shielding layer 410 on the base substrate 100.

Preferably, it is possible that the light-shielding layer 410 is directly formed at a bottom surface of the base substrate 100, and the light-reflecting layer 420 is formed at a bottom surface of the light-shielding layer 410. As such, the manufactured 3D display device may not need an individual grating substrate any longer, and with this structure, the light transmittance of the display device is increased. When the grating layer is directly formed on the base substrate 100, it is possible that the light-shielding layer 410 is formed at a bottom surface of the base substrate, and also the light-reflecting layer 420 is formed at a bottom surface of the light-shielding layer 410 with a patterning process (which usually includes photoresist coating, exposure, development, etching, photoresist stripping and so on). As compared with a process in which a separately fabricated grating substrate is attached to a display panel, the precision of alignment between the grating layer and sub-pixels in the pixel array layer 200 can be enhanced by the array substrate of the embodiment.

Steps of manufacturing the array substrate include that, a pixel array layer 200 is formed on a surface of the base substrate 100 at one side, and the pattern of a grating layer that is formed by arranging a plurality of light-blocking strips separated at a preset interval is formed at the other side of the base substrate. One specific example may be conducted as follows.

Firstly, a pixel array layer 200 is formed on a surface (the top surface in the figure) of the base substrate 100 at one side; and an opaque thin film of a light-shielding material is formed on a surface (the bottom surface in the figure) of the base substrate 100 at the other side. A light-proof black resin may be used as the light-shielding material, and the thin film of the light-shielding material is formed into the pattern of the light-shielding layer 410 for light-shielding strips through a patterning process. Next, a thin film of a light-reflecting material that may be a metallic material is formed, and is formed into the pattern of the light-reflecting layer 420 for light-shielding strips through a patterning process, and the projection of the light-reflecting layer 420 on the base substrate 100 is covered by the projection of the light-shielding layer 410 on the base substrate 100.

In another example according to the embodiment, the light-shielding layer 410 and the light-reflecting layer 420 may also be formed through a same patterning process. Namely, an opaque thin film of a light-shielding material and a thin film of a light-reflecting material are formed sequentially on the surface of the base substrate 100 at the other side, and the stacked thin-films are formed into the pattern of the light-shielding layer 410 and the light-reflecting layer 420 for light-blocking strips through the same patterning process. Additionally, in the embodiment, no limitation will be imposed upon the order in which the pixel array layer 200 and the grating layer are formed on a surface of the base substrate 100.

In the embodiment, the grating layer is so produced that it is located under the base substrate 100. Upon 3D display, the light-reflecting layer 420 in the grating layer can reflect light that is not transmitted through the grating layer back to a backlight source, and then it is diffused by the light guide plate in the backlight source, so that the diffused light can pass through the grating layer. This increases brightness of the display device.

### Embodiment 2

As for a liquid crystal display device, generally, a lower polarizing sheet may be required under the base substrate 100 as well, and thus, on the basis of Embodiment 1, an array substrate according to the embodiment further includes a polarizing sheet 300 at a side of the light-blocking strips 400 away from the pixel array layer 200. As shown in FIG. 5, the polarizing sheet 300 is formed under the light-reflecting layer 420. In manufacture, on the basis of the manufacturing procedure in Embodiment 1, the polarizing sheet 300 is directly formed under the light-reflecting layer 420, as long as the light-reflecting layer 420 has been formed before manufacture of the polarizing sheet 300.

Certainly, as shown in FIG. 6, a polarizing sheet 300 may also be formed between a light-shielding layer 410 of the light-blocking strips and a base substrate 100. Namely, it is possible that the light-shielding layer 410 is directly formed at the bottom surface of the polarizing sheet 300, and a light-reflecting layer 420 is formed at the bottom surface of the light-shielding layer 410.

One specific embodiment may be carried out as follows. A pixel array layer 200 is formed on a surface (the top surface in the figure) of the base substrate 100 at one side; the polarizing sheet 300 is formed on a surface (the bottom surface in the figure) of the base substrate 100 at the other side; an opaque thin film of a light-shielding material that may be a black resin material is formed on the bottom surface of the polarizing sheet 300 at the other side, and is formed into the pattern of the light-shielding layer 410 for light-shielding strips through a patterning process; a thin film of a light-reflecting material that may be a metallic material is formed, and it is formed into the pattern of the light-reflecting layer 420 for the light-shielding strips through a patterning process, and the projection of the light-reflecting layer 420 on the base substrate 100 is covered by the projection of the light-shielding layer 410 on the base substrate 100.

In another example according to the embodiment, the light-shielding layer 410 and the light-reflecting layer 420 may also be formed through a same patterning process. Namely, an opaque thin film of a light-shielding material and a thin film of a light-reflecting material are formed sequentially on a bottom surface of the polarizing sheet 300, and the stacked thin-films are formed into the pattern of the light-shielding layer 410 and the light-reflecting layer 420 for the light-blocking strips through the same patterning process. Additionally, in the embodiment, no limitation will be imposed upon the order in which the pixel array layer 200 and the grating layer are formed on a surface of the base substrate 100.

The embodiment and Embodiment 1 have similar beneficial effects, and details are omitted here.

### Embodiment 3

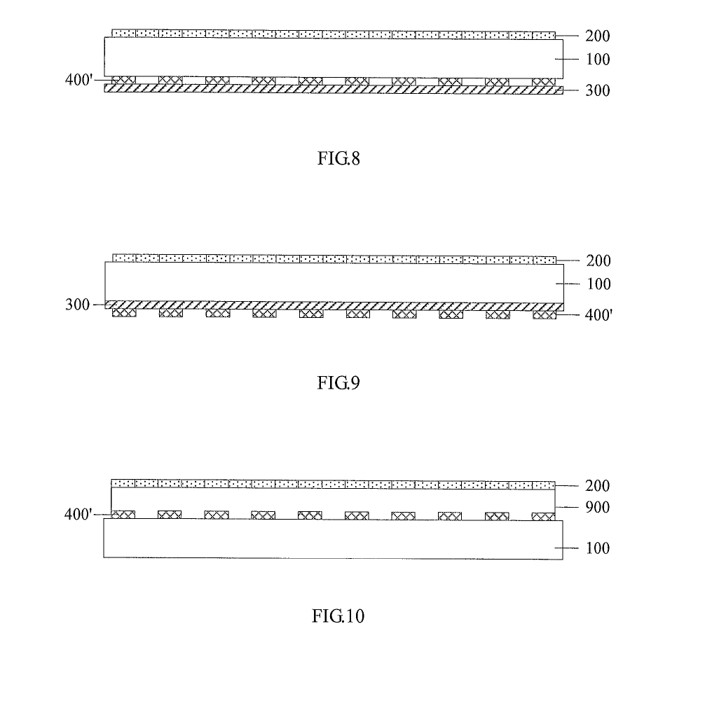

An array substrate provided by the embodiment, as shown in FIG. 7, includes: a base substrate 100 (such as a transparent substrate of glass or quartz material) and a pixel array layer 200 located on the base substrate 100. The pixel array layer 200 in operation is adjacent to a liquid crystal layer. The array substrate further includes: a grating layer that is located under the base substrate 100 and is formed by a plurality of light-blocking strips 400′ separated at a preset interval.

In the embodiment, each of the light-blocking strips 400′ is made of a light reflecting material. The light reflecting material is light-proof, which is also applicable to the embodiments stated below. Preferably, it is possible that the light-blocking strips 400′ are directly formed at the bottom surface of the base substrate 100. In this way, the manufactured 3D display device may not need a grating substrate any longer, and with this structure, the light transmittance of the display device is increased. When the grating layer is directly formed on the base substrate 100, it is possible that the light-blocking strips 400′ are formed at the bottom surface of the base substrate by using a patterning process (which usually includes photoresist coating, exposure, development, etching, photoresist stripping and other process), and as compared with an attachment process, the precision of alignment between the grating layer and sub-pixels in the pixel array layer 200 is enhanced by this.

Steps of manufacturing the array substrate include that, a pixel array layer 200 is formed on a surface of the base substrate 100 at one side, and the pattern of a grating layer that is formed by arranging a plurality of light-blocking strips 400′ separated at a preset interval is formed at the other side of the base substrate. One specific example may be carried out as follows.

The pixel array layer 200 is formed on a surface (the top surface in the figure) of the base substrate 100 at one side; and a thin film of a light-reflecting material is formed on a surface (the bottom surface in the figure) of the base substrate 100 at the other side. The light-reflecting material may be a metallic material, and the thin film of the light-reflecting material is formed into the pattern of light-shielding strips 400′ through a patterning process.

In the embodiment, no limitation will be imposed upon the order in which the pixel array layer 200 and the grating layer are formed on a surface of the base substrate 100.

In the embodiment, a light reflecting material is directly used for manufacture of the light-blocking strips 400′. Thus, not only a beneficial effect of enhancing brightness of the display device of Embodiment 1 is achieved, but also in comparison with Embodiment 1, the production process is simplified, and the cost is reduced.

### Embodiment 4

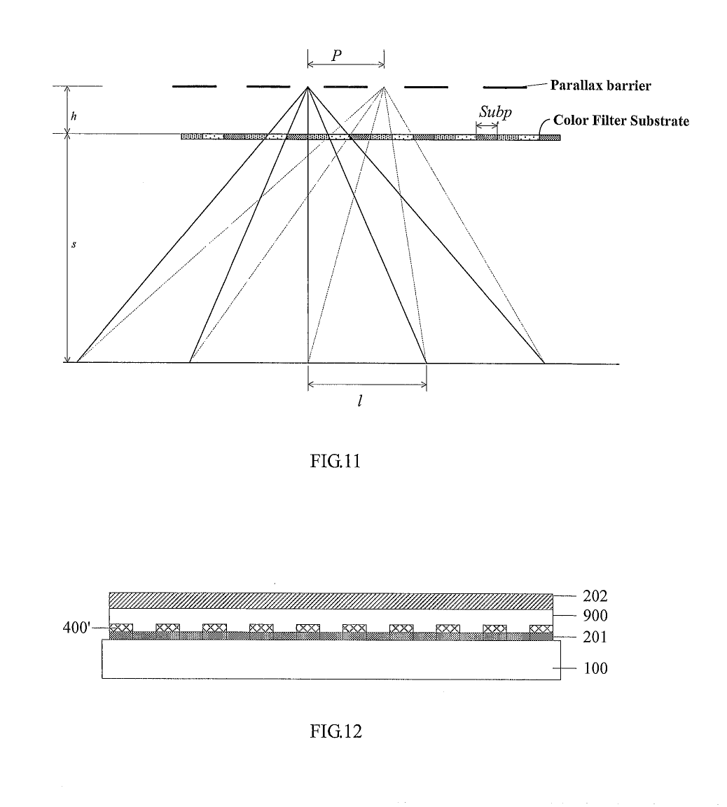

As for a liquid crystal display device, generally, a lower polarizing sheet may be required under a base substrate 100 as well, and thus, on the basis of Embodiment 3, an array substrate according to the embodiment further includes a polarizing sheet at a side of the light-blocking strips 400′ away from the pixel array layer. As shown in FIG. 8, the polarizing sheet 300 is formed under the light-blocking strips 400′. In manufacture, on the basis of the manufacturing procedure in Embodiment 3, the polarizing sheet 300 may be directly formed under the light-blocking strips 400′ as long as the light-blocking strips 400′ have been formed before manufacture of the polarizing sheet 300.

Certainly, as shown in FIG. 9, a polarizing sheet 300 may also be formed between light-blocking strips 400′ and a base substrate 100. Namely, the light-blocking strips 400′ are directly formed at the bottom surface of the polarizing sheet 300.

One specific embodiment may be carried out as follows.

The pixel array layer 200 is formed on a surface (the top surface in the figure) of the base substrate 100 at one side; the polarizing sheet 300 is formed on a surface (the bottom surface in the figure) of the base substrate 100 at the other side; a thin film of a light-reflecting material that may be a metallic material is formed on a bottom surface of the polarizing sheet 300, and it is formed into the pattern of the light-blocking strips 400′ through a patterning process.

In the embodiment, no limitation will be imposed upon the order in which the pixel array layer 200 and the grating layer are formed on a surface of the base substrate 100.

The embodiment and Embodiment 3 have similar beneficial effects, and details are omitted here.

### Embodiment 5

An array substrate provided by the embodiment, as shown in FIG. 10, includes: a base substrate 100 (such as a transparent substrate of glass or quartz material) and a pixel array layer 200 located on the base substrate 100. The array substrate further includes: a grating layer that is located between the base substrate 100 and the pixel array layer 200 and is formed by a plurality of light-blocking strips 400′ separated at a preset interval.

In the embodiment, the light-blocking strips 400′ are made of a light reflecting material. Preferably, it is possible that the light-blocking strips 400′ are directly formed at the top surface of the base substrate 100. When the light blocking strips 400′ are directly formed on the base substrate 100, the light-blocking strips 400′ are formed at the top surface of the base substrate 100 by using a patterning process (which usually includes photoresist coating, exposure, development, etching, photoresist stripping and other process), and as compared with an attachment process, the precision of alignment between the grating layer and sub-pixels in the pixel array layer 200 is enhanced in this way.

In an example, a polarizing sheet may also be provided at a side of the array substrate away from the pixel array layer 200 in the array substrate.

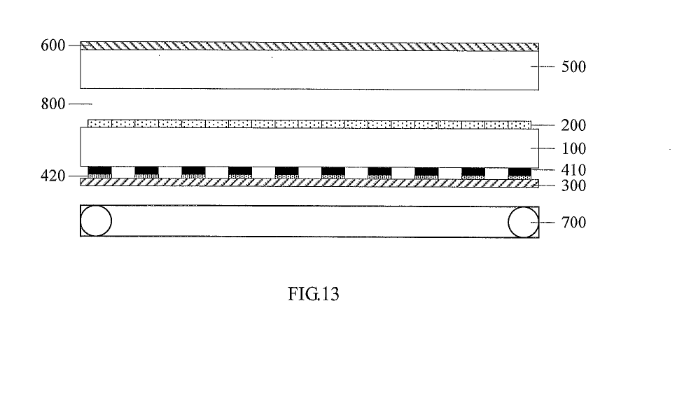

With reference to FIG. 11 and the following formulas (1) to (4), in order that a picture can seen clearly by a viewer within a suitable viewing distance “s” as well as keeping a distance “h” between a grating layer and a color filter substrate, light blocking strips 400′ of the grating layer and a pixel array layer 200 may also be separated with a spacing layer 900 for increasing the distance h. As can be seen from formula (3), when the pixel density in per inch on the array substrate (Pixels per inch, PPI) is large enough (such as above 2000), i.e. Subp becomes smaller, it is also possible that a clear picture can be seen by a viewer within a suitable viewing distance as well, without the necessity to add the spacing layer 900 additionally or increasing the thickness of a gate insulating layer, a passivation layer or the like in the pixel array layer 200.

$$\begin{matrix}\frac{2 Subp}{l} = \frac{h}{s + h} & ( 1 ) \\ \frac{4 Subp}{P} = \frac{s}{s + h} & ( 2 ) \\ h = \frac{2 s \cdot Subp}{l - 2 Subp} & ( 3 ) \\ P = \frac{4 l \cdot Subp}{l - 2 Subp} & ( 4 )\end{matrix}$$

Where P is a grating interval, Subp is the size of a sub-pixel, l is an interpupillary distance, h is the distance from the grating to the color filter substrate, and s is a viewing distance.

Steps of an example for manufacturing the array substrate are as follows.

The pattern of a grating layer that is formed by arranging a plurality of light blocking strips 400′ separated at a preset interval is formed at a side of a base substrate 100.

For example, a thin film of a light-reflecting material that may be a metallic material is formed on a surface (the top surface in the figure) of the base substrate 100 at one side, and it is formed into the pattern of the light-blocking strips 400′ through a patterning process.

A pixel array layer 200 is formed at a side of the grating layer away from the base substrate 100.

Of course, it is also possible that a spacing layer 900 is formed on the grating layer before the pixel array layer 200 is formed.

In the embodiment, the grating layer is produced between the base substrate 100 and the pixel electrode layer 200. In 3D display, the light-blocking strips 400′ in the grating layer can reflect light that is not transmitted through the grating layer back to a backlight source, and then they are diffused by the light guide plate in the backlight source, so that the diffused light can pass through the grating layer. Thereby, the brightness of the display device is increased.

### Embodiment 6

An array substrate according to the embodiment, as shown in FIG. 12, includes: a base substrate 100 (such as a transparent substrate of glass or quartz material) and a pixel array layer located on the base substrate 100. As shown in the figure, the pixel array layer includes the layers of a thin film transistor (including a gate line layer, a gate insulating layer, an active layer, a source/drain layer), a pixel electrode layer 201, a passivation layer, an aligning layer 202, and so on, which are formed on the base substrate 100. The gate line layer includes a gate line and a gate electrode of the thin film transistor; and the source/drain layer includes a data line and the source and drain electrodes of the thin film transistor. The array substrate further includes: a grating layer that is located between the pixel electrode layer 201 and the aligning layer 202 and is formed by a plurality of light-blocking strips 400′ separated at a preset interval.

In the embodiment, the light-blocking strips 400′ are made of a light reflecting material. Preferably, it is possible that the light-blocking strips 400′ are directly produced on the pixel electrode layer 201. When the light blocking strips 400′ are directly formed on the pixel electrode layer 201, the light-blocking strips 400′ are formed on the pixel electrode layer 201 by using a patterning process (which usually includes photoresist coating, exposure, development, etching, photoresist stripping and other process), and as compared with an attachment process, the precision of alignment between the grating layer and the pixel array layer is enhanced in this way.

In an example, a polarizing sheet may also be provided at a side of the array substrate 100 away from the pixel array layer 200 in the array substrate.

In order that a picture can be seen clearly by a viewer within a suitable viewing distance “s” as well as keeping the distance between a grating layer and a color filter substrate, light blocking strips 400′ of the grating layer and the aligning layer 202 may also be separated with a spacing layer 900. Based on the same principle as in Embodiment 3, when the pixel density in per inch on the array substrate (Pixels per inch, PPI) is large enough, a clear picture can also be seen by a viewer within a suitable viewing distance without the spacing layer 900.

Steps of an example for manufacturing the array substrate are as follows.

The pattern of a pixel electrode layer 201 in the pixel array layer is formed at a side of a base substrate 100.

The pattern of a grating layer that is formed by arranging a plurality of light blocking strips separated at a preset interval is formed at a side of the pixel electrode layer 201 away from the base substrate 100.

For example, a thin film of a light-reflecting material that may be a metallic material is formed on a surface (the top surface in the figure) of the pixel electrode layer 201 at one side, and it is formed into the pattern of the light-blocking strips 400′ through a patterning process.

An aligning layer 202 is formed at a side of the grating layer away from the base substrate 100 (above the grating layer). The aligning layer is such as a polyimide (PI) layer, and its surface may be rubbed to form fine grooves.

Of course, according to requirements, it is also possible that a spacing layer 900 is formed on the grating layer before the pixel electrode layer 201 is formed.

In the embodiment, the grating layer is produced between the pixel electrode layer 201 and the aligning layer 202. In 3D display, the light-blocking strips 400′ in the grating layer can reflect light that is not transmitted through the grating layer back to a backlight source, and then they are diffused by a light guide plate in the backlight source, so that the diffused light can pass through the grating layer. Thereby, the brightness of the display device is increased.

### Embodiment 7

According to the embodiment, there is provided a 3D display device, comprising the array substrate as stated in any of the above Embodiments 1 to 6. FIG. 13 shows a 3D display device including an array substrate in Embodiment 2. In the 3D display device, a backlight source 700 is provided below an array substrate 100, a color filter substrate 500 (with an upper polarizing sheet 600 provided thereon also) is provided above the array substrate 100, and a liquid crystal layer 800 is between the array substrate 100 and the color filter substrate 500.

The 3D display device may be a liquid crystal panel, a cell phone, a tablet computer, a television set, a display, a notebook computer, a digital photo frame, a navigator or any other product or component having a display function.

The descriptions made above are merely exemplary embodiments of the invention, but are not used to limit the protection scope of the invention. The protection scope of the invention is defined by attached claims.

1: An array substrate, comprising: a base substrate, a pixel array layer located on the base substrate and a grating layer for 3D display that is formed by a plurality of light blocking strips separated at a preset interval,
wherein the grating layer is located at a side of the base substrate facing the pixel array layer, or the grating layer is located at a side of the base substrate away from the pixel array layer, and the light blocking strips have a property of reflecting light, and is configured to reflect light that is to be emitted through the base substrate to the pixel array layer.

2: The array substrate claimed as claim 1, wherein the pixel array layer includes a pixel electrode layer and an aligning layer located at a side of the pixel electrode layer away from the base substrate, and the grating layer is located between the pixel electrode layer and the aligning layer.

3: The array substrate claimed as claim 2, further comprising a spacing layer disposed on the grating layer, wherein the aligning layer is disposed on the spacing layer.

4: The array substrate claimed as claim 1, wherein the grating layer is located at a side of the base substrate facing the pixel array and the grating layer is located at a side of the pixel array layer away from the base substrate.

5: The array substrate claimed as claim 4, further comprising a spacing layer, wherein the grating layer is located at a side of the base substrate facing the pixel array and the pixel array layer is disposed on the spacing layer.

6: The array substrate claimed as claim 1, wherein the light blocking strips are made of a light reflecting material.

7: The array substrate claimed as claim 1, wherein the grating layer is located at a side of the base substrate away from the pixel array layer, and the light blocking strips include a light shielding layer and a light reflecting layer, the light shielding layer is located between the base substrate and the light reflecting layer, and a projection of the light reflecting layer on the base substrate is covered by a projection of the light shielding layer on the base substrate.

8: The array substrate claimed as claim 1, further comprising a polarizing sheet located at a side of the base substrate away from the pixel array layer.

9: The array substrate claimed as claim 8, wherein the grating layer is located at a side of the base substrate away from the pixel array layer, and the grating layer is located at a side of the polarizing sheet away from the pixel array layer or located at a side of the polarizing sheet facing the pixel array layer.

10: A three-dimensional (3D) display device, comprising the array substrate claimed as claim 1.

11: A manufacturing method of an array substrate, comprising:
forming a pixel array layer on a surface of a base substrate at one side;
forming a pattern of a grating layer for 3D display, that is formed by arranging a plurality of light blocking strips separated at a preset interval, at the other side of the base substrate,
wherein the light blocking strips have a property of reflecting light.

12: The manufacturing method of the array substrate claimed as claim 11, wherein the pattern of the grating layer for 3D display, that is formed by arranging a plurality of the light blocking strips separated at a preset interval, is directly formed on a surface of the base substrate at the other side.

13: The manufacturing method of the array substrate claimed as claim 11, further comprising forming a polarizing sheet on a pattern surface of the grating layer.

14: The manufacturing method of the array substrate claimed as claim 11, wherein a polarizing sheet is formed on a surface of the base substrate at the other side; and the pattern of the grating layer for 3D display, that is formed by arranging a plurality of the light blocking strips separated at a preset interval, is formed on a surface of the polarizing sheet.

15: A manufacturing method of an array substrate, comprising:
forming a pattern of a pixel electrode layer in the pixel array layer at a side of the base substrate;
forming a pattern of a grating layer for 3D display, that is formed by arranging a plurality of light blocking strips separated at a preset interval, at a side of the pixel electrode layer away from the base substrate;
forming an aligning layer at a side of the grating layer away from the base substrate;
wherein the light blocking strips have a property of reflecting light.

16: A manufacturing method of an array substrate, comprising:
forming a pattern of a grating layer for 3D display, that is formed by arranging a plurality of light blocking strips separated at a preset interval, at a side of the base substrate;
forming a pixel array layer at a side of the grating layer away from the base substrate;
wherein the light blocking strips have a property of reflecting light.

17: The array substrate claimed as claim 2, further comprising a polarizing sheet located at a side of the base substrate away from the pixel array layer.

18: The array substrate claimed as claim 4, further comprising a polarizing sheet located at a side of the base substrate away from the pixel array layer.

19: The array substrate claimed as claim 7, further comprising a polarizing sheet located at a side of the base substrate away from the pixel array layer.

20: The manufacturing method of the array substrate claimed as claim 12, further comprising forming a polarizing sheet on a pattern surface of the grating layer.
